(19) United States
(12) Patent Application Publication
(10) Pub. No.: US 2025/0094871 A1
(43) Pub. Date: Mar. 20, 2025

(54) TUNABLE AND ADAPTIVE MULTI-SOURCE DIGITAL CLONE

(71) Applicant: Government of the United States as represented by the Secretary of the Air Force, Wright-Patterson AFB, OH (US)

(72) Inventor: Trevor Bihl, Wheelersburg, OH (US)

(21) Appl. No.: 18/823,869

(22) Filed: Sep. 4, 2024

Related U.S. Application Data
(60) Provisional application No. 63/582,635, filed on Sep. 14, 2023.

(51) Int. Cl. G06N 20/00

(52) U.S. Cl. CPC G06N 20/00

(57) ABSTRACT

A method for digital cloning. The method includes collecting data about an autonomous agent. The collected data is input into a biasing module which produces modified data. The modified data is entered into a reasoning engine module to create a digital clone of the autonomous agent.

### RIGHTS OF THE GOVERNMENT

The invention described herein may be manufactured and used by or for the Government of the United States for all governmental purposes without the payment of any royalty.

### TECHNICAL FIELD

The disclosure generally relates to the field of digital cloning.

### BACKGROUND

A digital clone is of particular interest and use when a first autonomous agent is out of communication, either temporarily or permanently. If a second autonomous agent desires to query the out-of-communication first agent, the second autonomous agent can query the first agent's digital clone. A need exists for the ability to develop a digital clone of a person that can provide emulated behaviors and actions, e.g., answers to queries, from another person.

### BRIEF DESCRIPTION OF THE DRAWINGS

The accompanying drawings illustrate only some aspects of the disclosure and are not to be considered limiting of the disclosure scope.

FIG. 1 is a diagram illustrating an example of a method of the disclosure.

FIG. 2 is a flow diagram illustrating an exemplary method of the disclosure.

FIG. 3 is a schematic diagram of an example system of the disclosure.

The embodiments set forth in the drawings are illustrative in nature and not intended to be limiting. Moreover, individual features of the drawings and the disclosure will be more fully apparent and understood in view of the detailed description.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific FIG. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

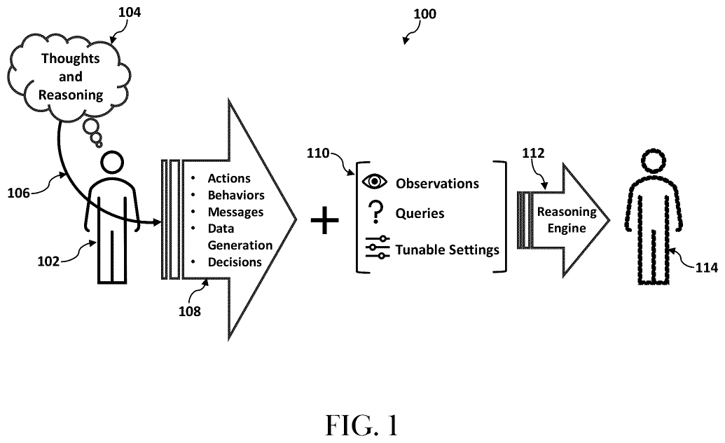

Referring to FIG. 1, there is shown a schematic representation 100 of a method for creating a digital clone from an autonomous agent, such as a person. An autonomous agent 102 engages in thoughts and reasoning 104, that manifest in outwardly 106 discernable conduct 108, including, among other things, actions, behaviors, messages, data generation, and decisions. These multi-source data of discernable conduct 108 are not exclusive, but representative of outwardly detectable deeds and comportments that can be noted and recorded qualitatively and quantitively. In an embodiment, the outwardly discernable conduct can be registered via certain registration operations 110, such as by direct and/or indirect observations of the autonomous agent 102, direct and indirect queries (including prompts) and tunable settings of various multi-source data, as described in more detail below. Once registration parameters are obtained, the data can be fed into a reasoning engine 112, as detailed below, and a digital clone 114 of the autonomous agent 102 can developed which can emulate the behavior of the autonomous agent 102.

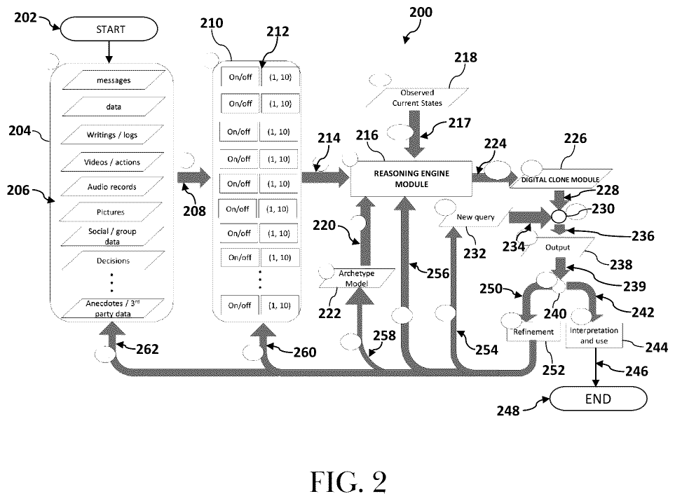

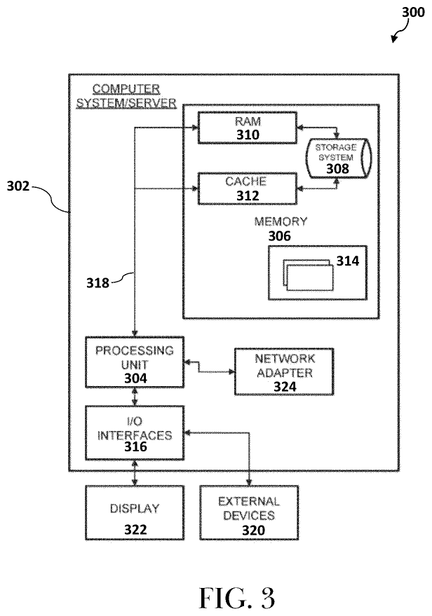

Referring to FIG. 2, a flow diagram 200 illustrates an exemplary method that operates in an exemplary system 300 (described with reference to FIG. 3) for producing a digital clone 114. The method runs on a system of data input and electronic processing. The system can comprise a processor, a memory, and executable instructions for carrying out the method. The method can create a digital clone that acts like, or similar to, the original autonomous agent. The digital clone can provide responses to inquiries if the autonomous agent is out of communication (willingly or unwillingly; temporarily or permanently). The method operates to create artificial intelligence (AI)-based reasoning and prediction from multi-source data. The method starts at 202, and at data module 204 multi-source data 206 are collected from (or about) the original autonomous agent 102, e.g., the donor, from which a digital clone is to be created. Multi-source data 206 can be passively or actively gathered and automatically or manually entered into the data module 204. Multi-source data 206 can include, but is not limited to, messages, including email and text messages, logs, decisions, writings, videos, records of actions, audio, pictures, states, socially collected data, social media data, and third-party data.

At Step 208, the multi-source data 206 is input to a biasing module 210. The biasing module 210 allows quantitative manipulation or modification of each of the multi-source data 206 with biasing factors 212 that can make the data more reliable in the method of digital cloning of the autonomous agent 102. A user (biological or artificial) can select from the available data and apply biasing factors based on the importance and weighting of the available data. The biasing factors can include “on” or “off” and can take the form of multipliers, which can be less than zero or greater than zero, including between −1 and +1. Thus, the data in the system can be modified by a user to provide an adaptive ability to match the outputs from the multi-source data 206 and/or provide for the ability to bias the digital clone 114 to provide outputs biased towards subsets of the data used, i.e. for simulation and testing of alternative representations.

At Step 214, the multi-source data 206 (optionally modified in the biasing module 210) is fed into a reasoning engine module 216 that can include the reasoning engine 112 described with reference to FIG. 1. Reasoning engines, such as Cyc, commercially available at www.cyc.com, or popular options such as ChatGPT, are artificial intelligence (AI) systems that mimic human-like decision-making and problem-solving capabilities based on certain rules, data, and logic. Sometimes referred to as a semantic reasoner, rules engine, or simply a reasoner, the reasoning engine resides in the reasoning engine module 216 as a piece of software operating in the operating system 300 (described with reference to FIG. 3) with memory and executable instructions to infer information from a set of data, including asserted facts or axioms. The reasoning engine can be a swappable AI-process or algorithm which models data and provides for a broadly capable digital clone.

The reasoning engine module 216 can be used to create the digital clone 114 of the autonomous agent 102. The reasoning engine module 216 can include further inputs used to create a digital clone, including observed current states 218 that can be input at Step 217 and can also be, or include, subsets of the multi-source data 206. The observed current states 218 can include the last known observations of the autonomous agent 102, which can also be selected and then input into the reasoning engine module 216. This feature facilitates considering how close the decision functions, which result from the reasoning engine, being able to compare and be trained for direct extrapolation of trends/responses continuing from the last observations.

Additional inputs to the reasoning engine module 216 can include inputs from an archetype model 222. In an embodiment, the archetype model 222 can be a prototype persona derived from the twelve typical human types, or archetypes, as outlined in Jungian psychological theory. In general, the archetype model 222 can be a selectable and tunable reference generic behavioral model which can be input at Step 220 to the reasoning engine module 216. In an embodiment, the input is after a user determines which archetype and parameters are desired. The archetype model 222 can leverage common and generic neuropsychological concepts, such as, but not limited to, Jungian archetypes (explorer, hero, etc.), basic behavioral constructs (aggression, achievement, etc.), safety, survivability, and risk considerations, basic personality characteristics (intuition, thinking, sensing, etc.), or moods (hunger, fear, curiosity, etc.) from which the reasoning engine can draw to create the digital clone. A reference baseline or null archetype model can be used to yield results as close to the autonomous agent 102 as possible; alternatively, the selections here can yield a digital clone which acts similar to the autonomous agent 102 but might have different personalities (i.e. more curious than the autonomous agent 102).

The reasoning engine module 216 outputs at Step 224 to a digital clone model 226. The digital clone model 226 can be a reference AI-generated model. Performance of the digital clone model 226 can be inputted at Step 228 a revision module 230 for consideration and possible revision. A new query (such as a prompt) 232 which can be a question or data that has possibly never been experienced by the original autonomous agent 102 can be input at Step 234 into the revision module 230. At Step 236 a revised output 238 can be produced that can be formatted as a combination or singular type of data (e.g., multi-source data 206) as used to create the original digital clone 114. At Step 239 the revised output 238 can be evaluated at evaluation module 240 by a user (biological or artificial) against performance parameters. At Step 242 the digital clone 114 can be put to use at block 244, Interpretation and Use. At step 246 the method can end at 248.

If further refinement of the digital clone 114 is desired, various refinement steps can be utilized in a feedback loop. At Step 250 the digital clone can be further refined at refinement module 252. The refinement module can prompt for and/or receive additional instructions and directives to the method 200, including modifying or tuning various inputs. For example, at Step 254 the refinement module 252 can prompt for a new or modified query to be inputted at 232; similarly, at Step 256 new or modified input into the reasoning engine module 216 can be made, and at Step 258, a new or modified archetype model 222 can be inputted. Likewise, at Step 260, the data fields in the biasing module 210 can be tuned, and at Step 262, the data module 204 can be modified. The method can continue in a system of inputs and feedback until at evaluation module 240 the digital clone 114 can be put to use at block 244 and the method ends at 248.

Referring now to FIG. 3, there is shown a schematic representation of an example system 300 for performing the method 200 of the disclosure. “System” as used herein refers broadly to all system elements comprising such a system, including the hardware, software, communications, and storage, including portions at a user location, portions at server/peer locations providing content and processing services, potentially including the entire Internet or any similar network to the extent that those elements are usable with the system and the resources that may be accessible to it.

FIG. 3 is a block diagram illustrating a system 300 configured to implement one or more aspects of the embodiments described herein. The system 300 can be a computing system that includes a processing subsystem 302 having one or more processor(s) 304 and a system memory 306 communicating via an interconnection path that may include a memory storage 308. RAM 310 and a cache 312 can be coupled to memory storage 308 and may be a separate component within memory storage 308, part of a chipset component 314 or may be integrated within the one or more processor(s) 304. The memory storage 308 couples with the processor(s) 304 and I/O interfaces 316 via a communication link 318. The I/O interfaces 316 can enable the computing system 302 to receive input from one or more external devices 320. Additionally, the I/O interfaces 316 can enable a display 322 controlled by a display controller, which may be included in the one or more processor(s) 302, to provide outputs to one or more other display device(s).

The computing system 302 can include other components not explicitly shown, including, for example, one or more parallel processor(s) coupled to the processing subsystem 302 via a bus or other communication link. The communication link may be one of any number of standards-based communication link technologies or protocols, such as, but not limited to PCI (Peripheral Component Interconnect) or TCP (Transmission Control Protocol) protocols or may be a vendor specific communications interface or communications fabric. The one or more parallel processor(s) may form a computationally focused parallel or vector processing system that can include a large number of processing cores and/or processing clusters, such as a many integrated core (MIC) processor.

Within the I/O interfaces 316, a system storage unit can connect to an I/O hub to provide a storage mechanism for the computing system 302. An I/O switch can be used to provide an interface mechanism to enable connections between the I/O hub and other components, such as a network adapter 324 and/or wireless network adapter that may be integrated into the system, and various other devices that can be added via one or more add-in device(s), such as, for example, one or more external graphics processor devices, graphics cards, and/or compute accelerators. The network adapter can be an Ethernet adapter or another wired network adapter. The wireless network adapter can include one or more of a Wi-Fi, Bluetooth, near field communication (NFC), or other network device that includes one or more wireless radios.

Other components of the computing system 302 not explicitly shown can include, for example, USB or other port connections, optical storage drives, video capture devices, and the like, which may also be connected to an I/O hub. Communication paths interconnecting the various components in FIG. 3 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) may incorporate circuitry optimized for graphics and video processing, including, for example, video output circuitry, and constitutes a graphics processing unit (GPU), a neuromorphic processing unit, and/or a central processing unit (CPU). Alternatively, or additionally, the one or more parallel processor(s) can incorporate circuitry optimized for general purpose processing, while preserving the underlying computational architecture, described in greater detail herein. Components of the computing system 302 may be integrated with one or more other system elements on a single integrated circuit. For example, one or more of parallel processor(s), memory hubs, processor(s), and I/O hubs can be integrated into a system on chip (SoC) integrated circuit. Alternatively, the components of the computing system 302 can be integrated into a single package to form a system in package (SIP) configuration. In one embodiment at least a portion of the components of the computing system 100 can be integrated into a multi-chip module (MCM), which can be interconnected with other multi-chip modules into a modular computing system.

It will be appreciated that the computing system 302 shown herein is illustrative and that variations and modifications are possible. The connection topology, including the number and arrangement of components, memory, the number of processor(s), and the number of parallel processor(s), may be modified as desired. For instance, system memory can be connected to the processor(s) directly rather than through a bridge, while other devices communicate with system memory via the processor(s). In other embodiments, the I/O interfaces and memory may be integrated into a single chip. It is also possible that two or more sets of processors are attached via multiple sockets, which can couple with two or more instances of the parallel processor(s).

All documents cited in the Detailed Description of the Disclosure are, in relevant part, incorporated herein by reference; the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A method for digital cloning, comprising,
collecting data about an autonomous agent;
inputting the data into a biasing module;
biasing the data to produce modified data;
entering the modified data into a reasoning engine module; and
creating a digital clone of the autonomous agent in the reasoning engine module.

2. The method for digital cloning of claim 1, further including entering observed current states into the reasoning engine module.

3. The method for digital cloning of claim 1, further including entering information from an archetype model into the reasoning engine module.

4. The method for digital cloning of claim 1, wherein the data includes digital messages selected from the group consisting of email messages and text messages.

5. The method for digital cloning of claim 1, wherein the data includes social media data.

6. The method of digital cloning of claim 1, wherein the biasing module includes multiplier factors.

7. The method of digital cloning of claim 1, wherein the reasoning engine module comprises an artificial intelligence system.

8. A method for digital cloning, comprising,
collecting data about an autonomous agent;
inputting the data into a biasing module;
biasing the data to produce modified data;
entering the modified data into a reasoning engine module;
creating a digital clone of the autonomous agent in the reasoning engine module;
developing a digital clone model; and
entering the digital clone model into a revision module.

9. The method for digital cloning of claim 8, further including entering observed current states into the reasoning engine module.

10. The method for digital cloning of claim 8, further including entering information from an archetype model into the reasoning engine module.

11. The method for digital cloning of claim 8, wherein the data includes digital messages selected from the group consisting of email messages and text messages.

12. The method for digital cloning of claim 8, wherein the data includes social media data.

13. The method of digital cloning of claim 8, wherein the biasing module includes multiplier factors.

14. The method of digital cloning of claim 8, wherein the reasoning engine module comprises an artificial intelligence system.

15. A system for digital cloning, comprising,
a memory;
a processor connected to the memory and having executable instructions to:
store entered data from an autonomous agent into the memory;
receive inputs from a user to modify the data; and
utilize a reasoning engine to develop a digital clone of the autonomous agent.

16. The system for digital cloning of claim 15, wherein the reasoning engine module comprises an artificial intelligence system.

17. The system for digital cloning of claim 15, further comprising an archetype model in the memory.

18. The system for digital cloning of claim 15, wherein the entered data include observed current states of the autonomous agent.

19. The system for digital cloning of claim 15, wherein the entered data includes digital messages selected from the group consisting of email messages and text messages.

20. The system for digital cloning of claim 15, further comprising a refinement model.
